(19) United States
(12) Patent Application Publication
(10) Pub. No.: US 2017/0113778 A1
(43) Pub. Date: Apr. 27, 2017

(54) DETACHABLE WING SYSTEM FOR AIRCRAFTS

(71) Applicant: EVOLVING RESOURCES, INC., Camarillo, CA (US)

(72) Inventors: Marcos Liu, Camarillo, CA (US); Jeffrey Raymond Tolomeo, Camarillo, CA (US); Ronald Derhacopian, Camarillo, CA (US)

(73) Assignee: EVOLVING RESOURCES, INC., Camarillo, CA (US)

(21) Appl. No.: 15/283,227

(22) Filed: Sep. 30, 2016

Related U.S. Application Data
(60) Provisional application No. 62/236,133, filed on Oct. 1, 2015.
(60) Provisional application No. 62/238,621, filed on Oct. 7, 2015.

(51) Int. Cl. B64C 1/26; B64C 3/10; B64C 3/16; B64C 39/02

(52) U.S. Cl. CPC B64C 1/26; B64C 39/024; B64C 3/10; B64C 3/16; B64C 2201/021

(57) ABSTRACT

Devices and methods described herein can use novel and efficient designs and layouts to improve the flight performance of unmanned aerial vehicles (UAVs). Some embodiments of the present disclosure can comprise a UAV including a novel and efficient wing design, while other embodiments can comprise a novel and efficient wing design for use with different UAVs. In this manner, wing systems and/or structures according to the present disclosure can have different sizes and/or be scaled to work with differently sized of UAVs. In other embodiments according to the present disclosure, the wing structures can have release mechanisms, wherein the wing structure can be detachable from the rest of the UAV. Some embodiments include a wing structure comprising a center wing panel connected to left and right wing panels. In some embodiments, the left/center/right wing panels are connected with a pin/slot system.

### CROSS REFERENCE TO RELATED APPLICATIONS

This application claims the benefit of U.S. Provisional Patent Application 62/236,133 to Liu et al., filed on Oct. 1, 2015, and U.S. Provisional Patent Application 62/238,621 to Liu et al., filed on Oct. 7, 2015, each of which is fully incorporated by reference herein in its entirety.

### BACKGROUND

Field

The present disclosure relates generally to aircraft devices, including unmanned aerial vehicles and assemblies with efficient flight designs, and also to efficient wing designs for use in such systems.

Description of the Related Art

An unmanned aerial vehicle (UAV), also known as a drone or a remotely piloted vehicle (RPV), is an aircraft without a human pilot aboard. The flight of a UAV is controlled by the remote control of a pilot at another location and/or controlled autonomously by onboard computers.

There are many factors that affect the flight performance of UAVs, including the wing design. The size of the wing is often in proportion to the size of the UAV. However, many UAVs use wing systems and designs that fail to maximize the efficiency and the performance of the aircraft flight.

Accordingly, there is a present need for a novel and efficient wing design for UAVs, which specifically addresses the aforementioned and other challenges.

### SUMMARY

Described herein are devices and methods that use novel and efficient designs and layouts to improve the flight capability of UAVs. Moreover, devices and methods herein describe UAVs with wing systems and designs that can improve the overall flight performance. In some embodiments, the present disclosure can comprise an entire UAV including a novel and efficient wing design described herein. In other embodiments, the present disclosure can comprise a novel and efficient wing design for use with a number of different UAVs.

The present disclosure also relates to novel and efficient wing systems that can have different sizes and/or be scaled to work with different sizes of UAVs. In some embodiments, the wing systems of the present disclosure are scaled to work with specific types of UAVs, such as the Raven or Raven X, systems that are currently used by the U.S. Military. However, it is understood that wing systems according to the present disclosure can have a number of different dimensions and/or sizes, and are suitable for use with a number of different appropriately-sized UAVs.

In yet other embodiments, the wing system and/or structure can have one or more release mechanisms, wherein the wing system and/or structure can be detachable from other sections of the UAV. This structure may have a variety of advantages, such as reducing the likelihood of damage to the wing system and/or other UAV sections when the aircraft contacts the ground and/or another external object. However, it is understood that embodiments according to the present disclosure may have wing systems that are fully detachable, partially detachable, or not detachable from the other sections of the UAV.

### BRIEF DESCRIPTION OF THE DRAWINGS

FIG. 1 is a top side perspective view of one embodiment of a UAV according to the present disclosure;

FIG. 2 is a bottom side perspective view of the UAV in FIG. 1;

FIG. 3 is a front view of the UAV in FIG. 1;

FIG. 4 is a top view of one embodiment of a wing structure according to the present disclosure;

FIGS. 5a-5g are different views of one embodiment of a left wing according to the present disclosure;

FIGS. 6a-6g are different views of one embodiment of a right wing according to the present disclosure;

FIGS. 7a-7g are different views of one embodiment of a center wing according to the present disclosure;

FIGS. 8a and 8b are top views of an embodiment of a wing structure according to the present disclosure;

FIGS. 9a-9v are different views of an embodiment of a wing structure according to the present disclosure;

FIGS. 10a-10c display different wing structures according to the present disclosure;

FIGS. 11a-11d are one embodiment of a wing pin according to the present disclosure;

FIGS. 12a-12c are another embodiment of a wing pin according to the present disclosure; and

FIGS. 13a-13c are another embodiment of a wing pin according to the present disclosure.

### DETAILED DESCRIPTION

Devices and methods described herein can use novel and efficient designs and layouts to improve the flight performance of UAVs. Some embodiments of the present disclosure can comprise a UAV including a novel and efficient wing design, while other embodiments can comprise a novel and efficient wing design for use with different UAVs. In this manner, wing systems and/or structures according to the present disclosure can have different sizes and/or be scaled to work with differently sized of UAVs. In other embodiments according to the present disclosure, the wing systems and/or structures can have release mechanisms. Accordingly, the wing system and/or structure can be detachable from the rest of the UAV.

One embodiment according to the present disclosure includes a wing structure comprising: a center wing panel, a left wing panel connected to the center wing panel, and a right wing panel connected to the center wing panel, wherein the center wing panel comprises a connection portion for connecting to an unmanned aerial vehicle.

Another embodiment according to the present disclosure includes a wing structure comprising: a center wing panel comprising one or more center connection slots, a left wing panel comprising one or more left connection pins connected to the one or more center connection slots, and a right wing panel comprising one or more right connection pins connected to the one or more center connection slots.

In yet another embodiment, the present disclosure can comprise an unmanned aerial vehicle which comprises a main body, a wing structure detachably connected to the main body, a tail boom connected to the main body, a vertical stabilizer connected to the tail boom, and a horizontal stabilizer connected to the tail boom.

Throughout this disclosure, the preferred embodiment and examples illustrated should be considered as exemplars, rather than as limitations on the present disclosure. As used herein, the term “invention,” “device,” “apparatus,” “method,” “disclosure,” “present invention,” “present device,” “present apparatus,” “present method” or “present disclosure” refers to any one of the embodiments of the disclosure described herein, and any equivalents. Furthermore, reference to various feature(s) of the “invention,” “device,” “apparatus,” “method,” “present invention,” “present device,” “present apparatus,” or “present method” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, it is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “inner,” “outer,” “upper,” “top,” “above,” “lower,” “bottom,” “beneath,” “below,” and similar terms, may be used herein to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although the terms first, second, third, etc., may be used herein to describe various elements, components, regions, and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present disclosure. As used herein, the term “and/or” includes any and all combinations of one or more of the associated list items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. For example, when the present specification refers to “an” assembly, it is understood that this language encompasses a single assembly or a plurality or array of assemblies. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

It is understood that while the present disclosure makes reference to UAVs with efficient wing designs, and that UAVs may be the primary application concerned with the present disclosure, devices incorporating features of the present disclosure can be utilized with any application that has components or elements which might be related to aerodynamics, such as airplanes, aircraft, and/or any object that may benefit from an efficient wing design.

Embodiments of the disclosure are described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in some of the figures are schematic in nature, and their shapes may not represent the precise shape of an element and are not intended to limit the scope of the disclosure unless specifically indicated otherwise. Within the disclosure, some embodiments are shown including elements having specific dimensions; although some dimensions and/or ratios of dimensions may improve performance, such embodiments are meant to be exemplary unless indicated otherwise.

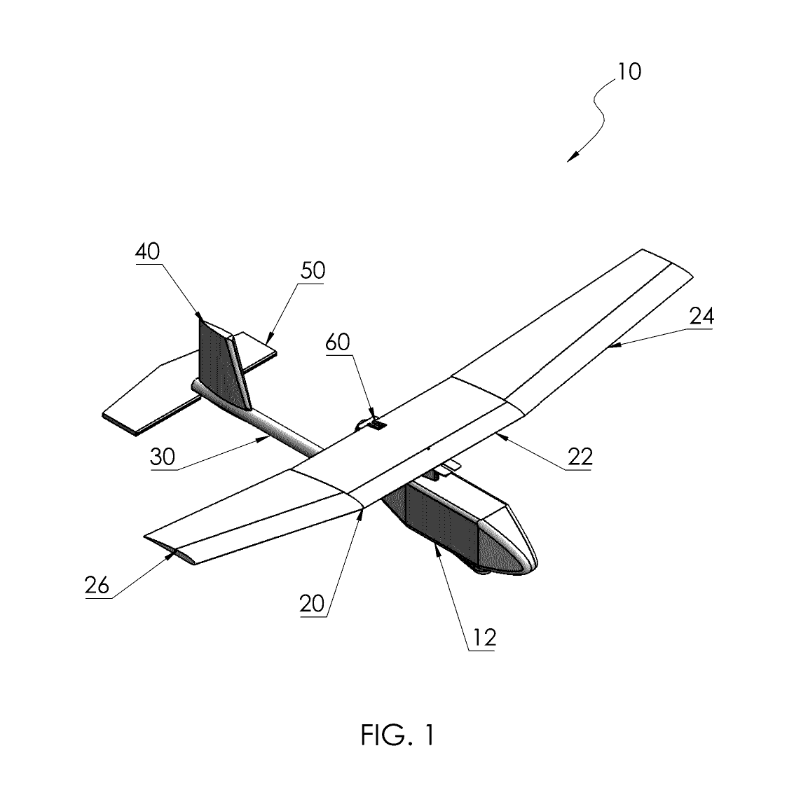

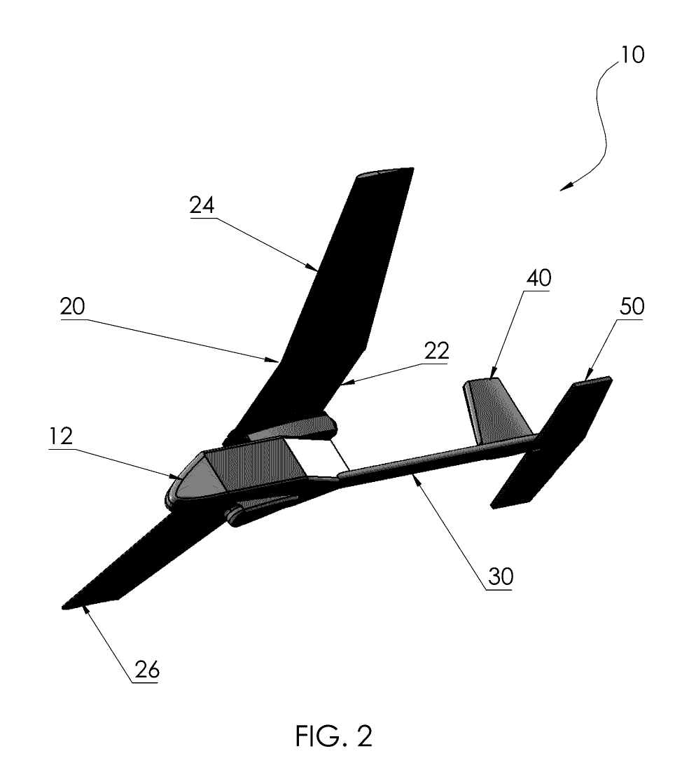

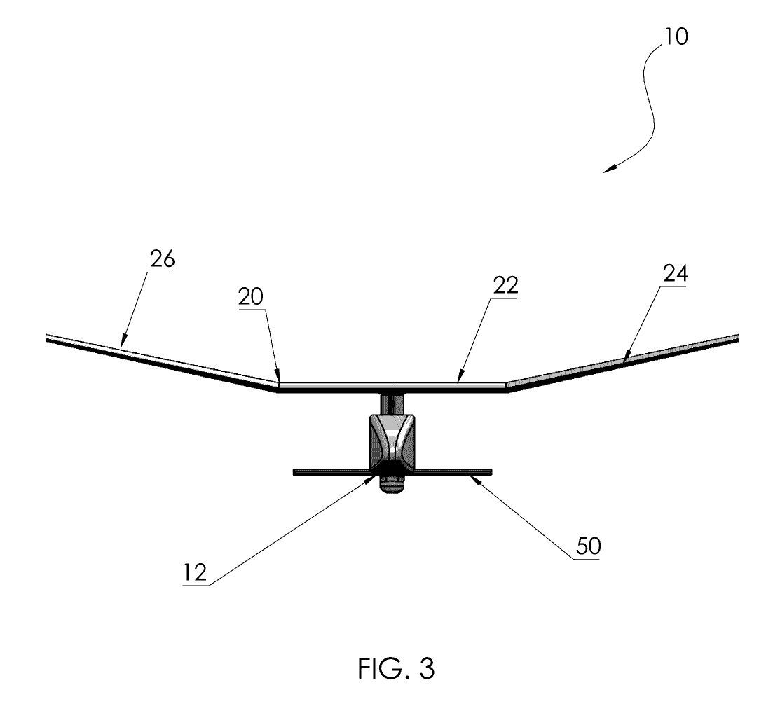

FIG. 1 is a top side perspective view of one embodiment of a UAV 10 according to the present disclosure. As shown in FIG. 1, UAV 10 can comprise fuselage and/or main body 12 and wing structure 20, which can also comprise center wing panel 22, left wing panel 24, and right wing panel 26. The rear portion of UAV 10 can comprise tail boom 30, vertical stabilizer 40, and/or horizontal stabilizer 50. FIG. 2 is a bottom side perspective view of UAV 10 in FIG. 1, while FIG. 3 is a front view of UAV 10 in FIG. 1.

As mentioned previously, wing structure 20 can be detachable from the rest of UAV 10. In some embodiments, wing structure 20 can attach and detach from UAV 10 at wing connection mechanism 60. In some embodiments, center wing panel 22 can comprise wing connection mechanism 60. In other embodiments, wing connection mechanism 60 can be detachably connected to fuselage and/or main body 12. In yet other embodiments, wing connection mechanism 60 can be detachably connected to tail boom 30. In yet other embodiments, fuselage and/or main body 12 can comprise wing connection mechanism 60, which is detachably connected to wing structure 20. However, it is understood that wing structure 20 can attach and/or detach at other UAV locations as well. It is also understood that in some embodiments wing structure 20 is permanently affixed to UAV 10.

In some embodiments according to the present disclosure, wing connection mechanism 60 can comprise a clip that can attach and detach wing structure 20. The clip can allow the wing structure 20 to be attached and detached to UAV 10. In some embodiments, the clip can hold and/or clip wing structure 20 to UAV 10, as well as be inserted through wing structure 20 or another portion of UAV 10. However, it is understood that the clip can attach and detach wing structure 20 in a number of different ways. The clip can allow wing structure 20 to be securely attached to, as well as detachable from, UAV 10 without the use of another connection means, such as gaffer's tape, for example.

As mentioned above, wing structures according to the present disclosure are configured to detach from the main body, for example, with a breakaway action. For example, when the UAV impacts another object and/or the ground, the wing structure can be designed to detach and breakaway from the main body. By doing so, energy will be transferred to the breakaway process, and can reduce damage to the wing structure and/or the main body. Accordingly, this breakaway function of the wing structure can reduce damage to the UAV upon impact with another object and/or the ground. In some embodiments, the connection portion is designed to detach from the main body upon impact with a breakaway action. In other embodiments, the connection portion is designed to detach from the wing structure upon impact with a breakaway action. However, it is understood that the connection portion, wing structure, and/or main body can all detach from one another with a breakaway action.

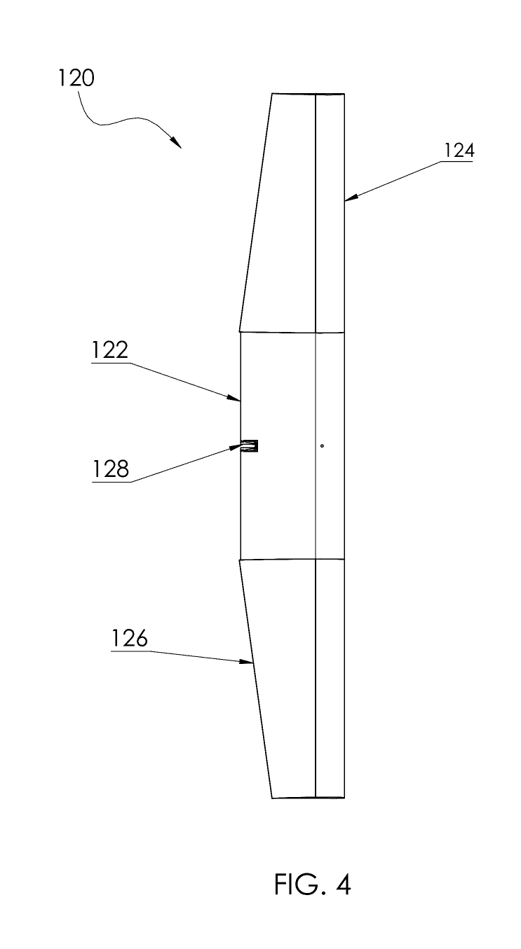

Wing structures according to the present disclosure can be configured to attach and detach to UAVs. FIG. 4 is a top view of one embodiment of a wing structure 120 according to the present disclosure. Wing structure 120 can comprise center wing panel 122, left wing panel 124, and/or right wing panel 126, as well as connection portion 128. As displayed in FIG. 4, connection portion 128 can allow wing structure 120 to attach and/or detach to a portion of a UAV. In some embodiments, the center wing panel 122 can comprise connection portion 128 for connecting to an unmanned aerial vehicle. In other embodiments, the clip described above can attach and detach to connection portion 128. However, it is understood that the clip described above, as well as any other connection means, can connect to any portion of wing structure 120.

In addition to connecting to a UAV, wing structures according to the present disclosure can also comprise different sections that connect together. For example, in some embodiments, wing structures can comprise a left wing panel, a right wing panel, and/or a center wing panel, all of which can connect to each other. As displayed in FIG. 4, center wing panel 122, left wing panel 124, and/or right wing panel 126 can all connect together to form wing structure 120. In some embodiments, center wing panel 122, left wing panel 124, and/or right wing panel 126 are detachably connected to each other.

In some embodiments, the left wing panel can comprise a tip end and a root end connected to the center wing panel, wherein the width of the root end is greater than the width of the tip end. Additionally, the right wing panel can comprise a tip end and a root end connected to the center wing panel, wherein the width of the root end is greater than the width of the tip end. In other embodiments, the center wing panel can be below or above the tip end of the left wing panel and/or the tip end of the right wing panel.

In yet other embodiments, the left wing panel can comprise a leading edge portion and a trailing edge portion, wherein the thickness of the leading edge portion can be greater or less than the thickness of the trailing edge portion. Additionally, the right wing panel can comprise a leading edge portion and a trailing edge portion, wherein the thickness of the leading edge portion is greater or less than the thickness of the trailing edge portion. In other embodiments, the leading edge portion and the trailing edge portion of the left wing panel can be divided by a split line spanning the length of the left wing panel. Moreover, the leading edge portion and the trailing edge portion of the right wing panel can be divided by a split line spanning the length of the right wing panel. However, it is understood that the split line can span any portion of the left, center, and/or right wing panels.

Embodiments according to the present disclosure can also include wing structures comprising advantageous dimensions and/or ratios. In one embodiment, the left wing panel can comprise the following dimensions: root-to-tip length=18.56 in., tip end width=5.51 in., root end width=8.00 in. Moreover, the left wing panel can comprise the following specific dimensions: edge-to-anti-rotational pin=2.70 in., anti-rotation pin-to-male connector pin=3.05 in., and male connector pin-to-edge=2.05 in. The length of the anti-rotation pin can be 0.25 in. and the male connector pin can be 0.75 in. The tip end thickness can be 0.50 in. and the root end thickness can be 0.78 in. Additionally, the washout can be 0.20 in.

Although wing structures according to the present disclosure may list specific dimensions, it is understood that these dimensions may vary depending on the intended application. As such, the ratios of wing structures according to the present disclosure are often more important and/or helpful. Furthermore, it is understood that the right wing panel can comprise similar ratios.

As indicated above, the left wing panel can comprise the following dimensions: root-to-tip length:tip end width:root end width=18.56:5.51:8.00. As further indicated above, the length ratios of the root end can be: edge-to-anti-rotation pin:anti-rotation pin-to-male connector pin:male connector pin-to-edge=2.70:3.25:2.05. The ratio of the pin length can be: anti-rotational pin:male connector pin=0.25:0.75. Also, the thickness ratio can be: tip end:root end=0.50:0.78.

As indicated above, it is understood that the right wing panel can have similar dimensions and/or ratios to the left wing panel discussed above. Accordingly, the right wing panel can have the following ratios: root-to-tip length:tip end width:root end width=18.56:5.51:8.00. Anti-rotational pin:male connector pin=0.25:0.75. Also, the thickness ratio can be: tip end:root end=0.50:0.78. In some embodiments, the length ratios of the root end for the right wing panel can be: edge-to-anti-rotational pin:anti-rotation pin-to-male connector pin:male connector pin-to-edge=2.83:3.13:2.04. In other embodiments, the ratio can be: edge-to-anti-rotational pin:anti-rotation pin-to-male connector pin:male connector pin-to-edge=2.83:2.92:2.04.

In some embodiments, the center wing panel can comprise the following dimensions: root-to-root length (edge-to-edge)=17.37 in. and root end width=8.00 in. Moreover, the center wing panel can comprise the following specific dimensions: edge-to-anti-rotation slot=2.77 in., anti-rotation slot-to-female connector slot=2.92 in., and female connector slot-to-edge=2.04 in. Other embodiments can comprise the following dimensions: edge-to-anti-rotation slot=2.64 in., anti-rotation slot-to-female connector slot=3.05 in., and female connector slot-to-edge=2.04 in. The root end thickness on both ends can be 0.78 in. Additionally, the connection portion can be 0.86 in. wide. In other embodiments, the connection portion can be 0.62 in. wide. In some embodiments, the width of the anti-rotation slots is 0.22 in. and the female connector slots is 0.31 in.

As indicated above, the center wing panel can comprise the following dimensions: root-to-root length:root end width=17.37:8.00. As further indicated above, the length ratios of the root end can be: edge-to-anti-rotation slot:anti-rotation slot-to-female connector slot:female connector slot-to-edge=2.77:2.92:2.04. In other embodiments, the length ratios of the root end can be: edge-to-anti-rotation slot:anti-rotation slot-to-female connector slot:female connector slot-to-edge=2.64:3.05:2.04. The ratio of the slot length can be: anti-rotation slots:female connector slots=0.22:0.31. Also, the thickness ratio can be: root end:root end=0.78:0.78.

The specific dimensions and/or ratios mentioned above are disclosed in U.S. Provisional Patent Application 62/236,133 and U.S. Provisional Patent Application 62/238,621, to each of which this application claims the benefit, and each of which is fully incorporated by reference herein in its entirety.

The dimensions and/or ratios mentioned above are advantageous in that they provide improved results compared to wing structures known in the art. The inventors have dedicated countless hours to researching wing structures, and the above dimensions and/or ratios are the result of such research. Accordingly, embodiments according to the present disclosure comprise wing structure dimensions and/or ratios that improve flight data for all types of aerial vehicles, not just UAVs.

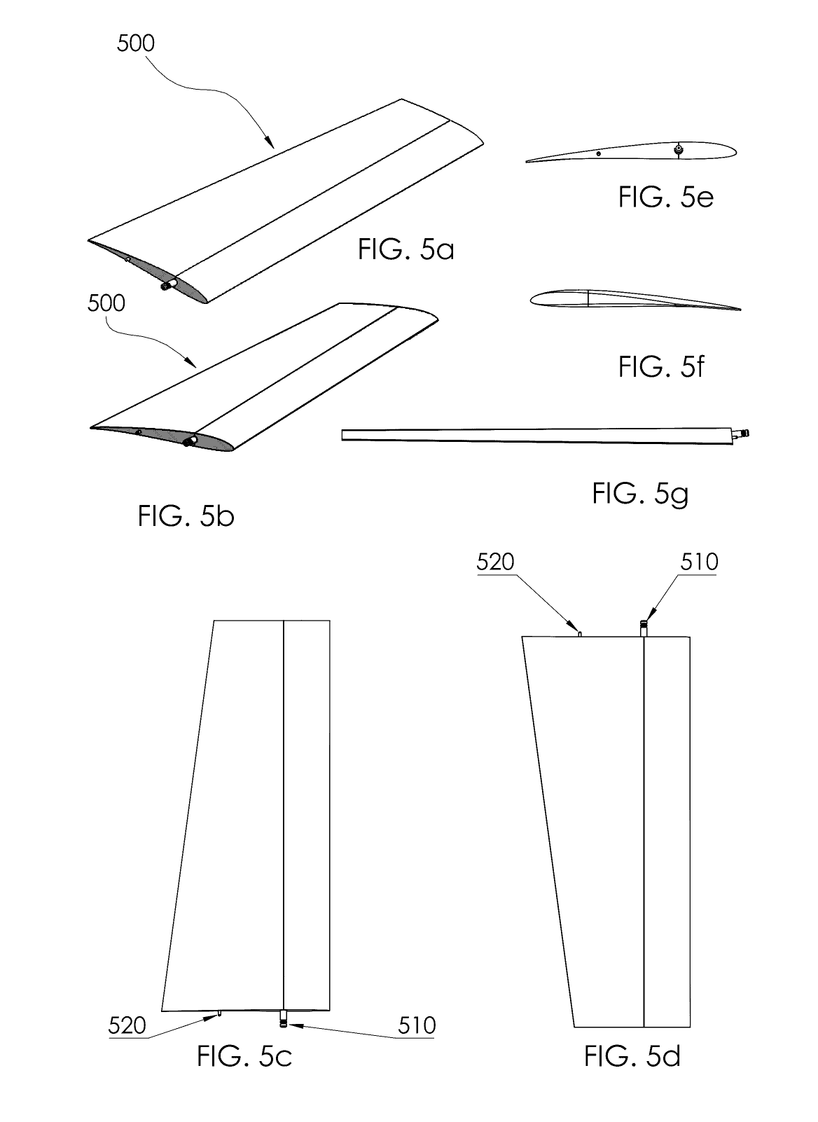

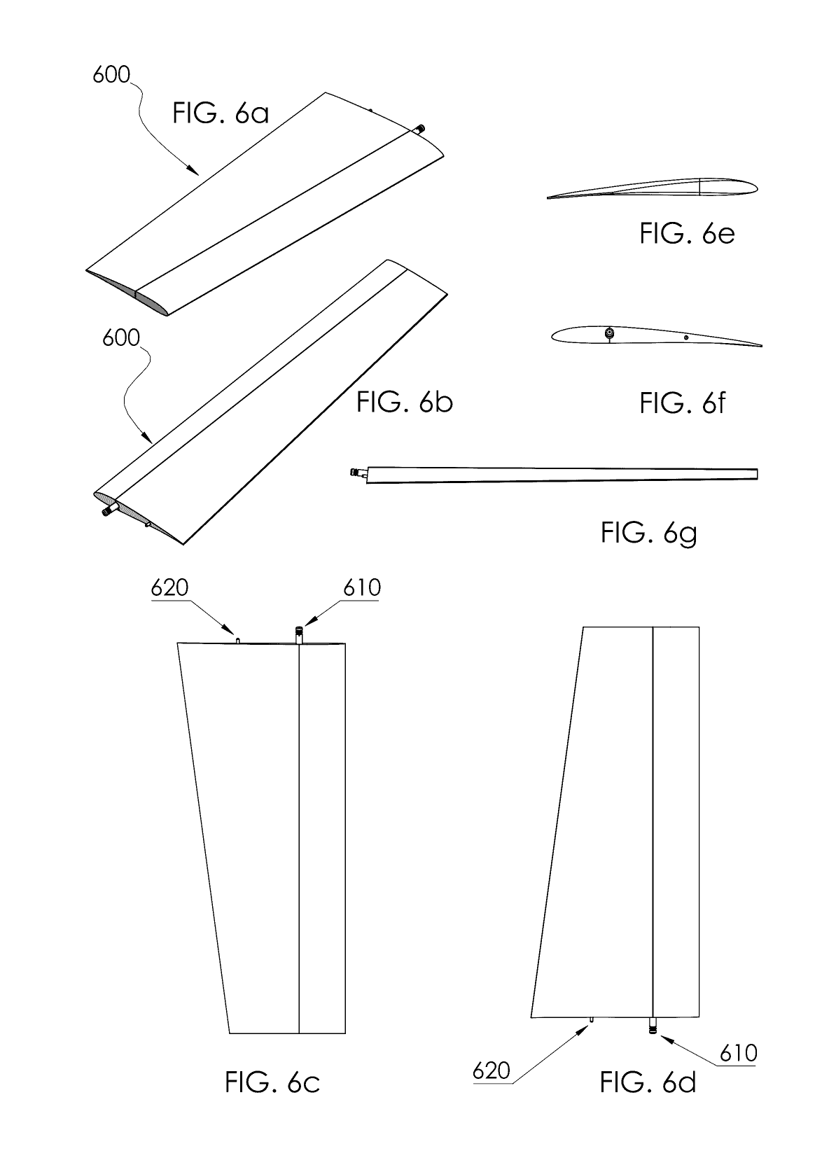

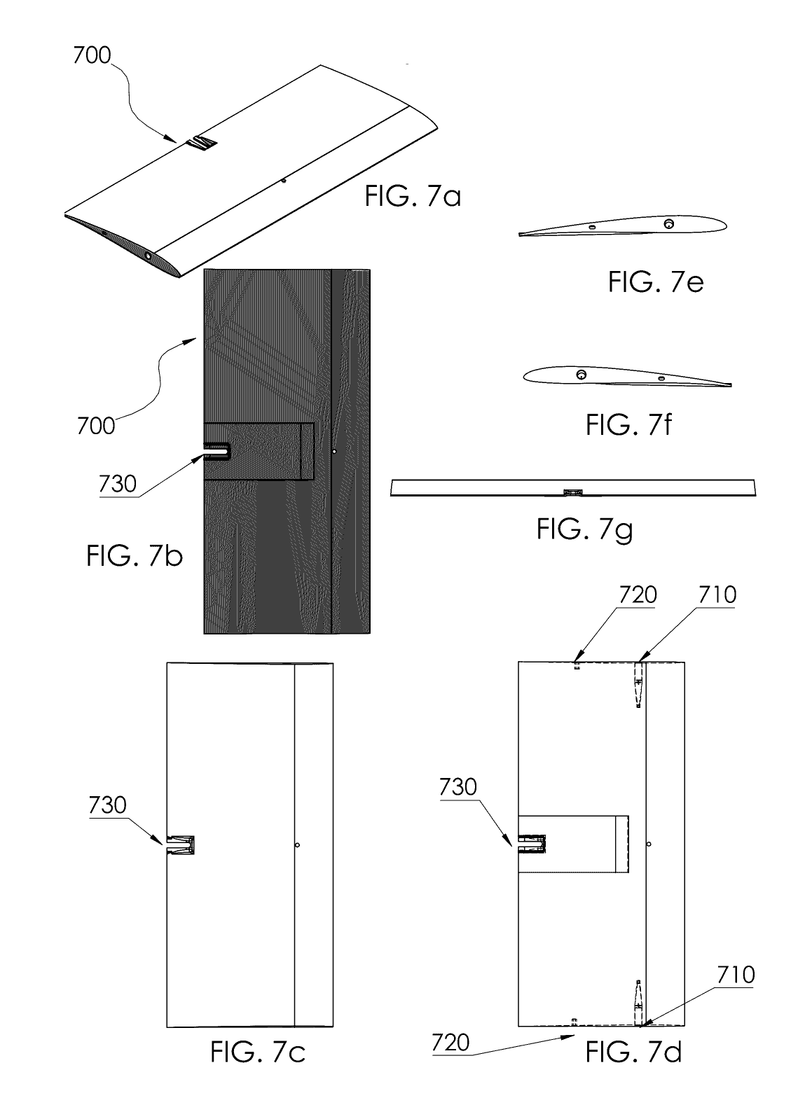

FIGS. 5a-5g, 6a-6g, and 7a-7g are different views of a left wing panel 500, a right wing panel 600, and a center wing panel 700, respectively. These figures display that each of these individual panels are connectable to form an entire wing structure. In order to help connect the individual panels to one another, the panels can comprise connection pins. FIGS. 5a-5g and 6a-6g display that the left wing panel 500 and the right wing panel 600 can comprise left male connection pins 510 and right male connection pins 610, respectively. FIGS. 7a-7g display that center wing panel 700 can comprise a female connection means or slots 710, wherein the male connection pins can insert into the female connection means or slots. However, it is understood that any of the wing panels can comprise male connection pins and/or female connection means or slots. Furthermore, it is understood that each of the wing panels can comprise any appropriate connection means. Additionally, the male connection pins and the female connection means or slots can be referred to as pins, fasteners, connecters, connection means, slots, and/or any other appropriate term. Center wing panel 700 can also comprise connection portion 730 for connecting to an unmanned aerial vehicle.

In some embodiments, the male connection pins can be increased in size due to the increased size of the wing structure. For example, either the diameter or the length of the pins can be increased based on the increased size of the wing structure. However, it is understood that the size of the pins can be increased or decreased depending on the size of the wing structure. Different sections of the wing panel can also comprise other components to help securely connect the panels to one another, such as O-rings. In some embodiments, as the size of the pins is adjusted, the location of the O-rings or other connection components can be correspondingly adjusted.

The separate wing panels can also comprise other components that can assist with connection and/or stabilization. For example, the left wing panel, the right wing panel, and/or the center wing panel can comprise stabilization components, such as anti-rotation pins. FIGS. 5a-5g, 6a-6g, and 7a-7g display anti-rotation pins 520/620 and anti-rotation connection means or slots 720 that can connect to one another and provide further stabilization as the individual panels connect together to form the wing structure.

In some embodiments, the center wing panel can comprise one or more center connection slots, the left wing panel can comprise one or more left connection pins connected to the one or more center connection slots, and/or the right wing panel can comprise one or more right connection pins connected to the one or more center connection slots. In other embodiments, the one or more center connection slots can comprise one or more female connector slots and/or one or more anti-rotation slots. In addition, the one or more left connection pins can comprise one or more left male connector pins and/or one or more left anti-rotation pins. Moreover, the one or more right connection pins can comprise one or more right male connector pins and/or one or more right anti-rotation pins.

In yet other embodiments, the one or more left male connector pins can be inserted into the one or more female connector slots and/or the one or more left anti-rotation pins can be inserted into the one or more anti-rotation slots. Likewise, the right male connector pins can be inserted into the one or more female connector slots and/or the one or more right anti-rotation pins can be inserted into the one or more anti-rotation slots.

In further embodiments, the left wing panel can comprise a leading edge portion and/or a trailing edge portion, wherein the leading edge portion and/or the trailing edge portion can be divided by a split line spanning the length of the left wing panel. Additionally, the right wing panel can comprise a leading edge portion and/or a trailing edge portion, wherein the leading edge portion and/or the trailing edge portion can be divided by a split line spanning the length of the right wing panel. And in yet other embodiments, the center wing panel can comprise a leading edge portion, a trailing edge portion, and/or a split line.

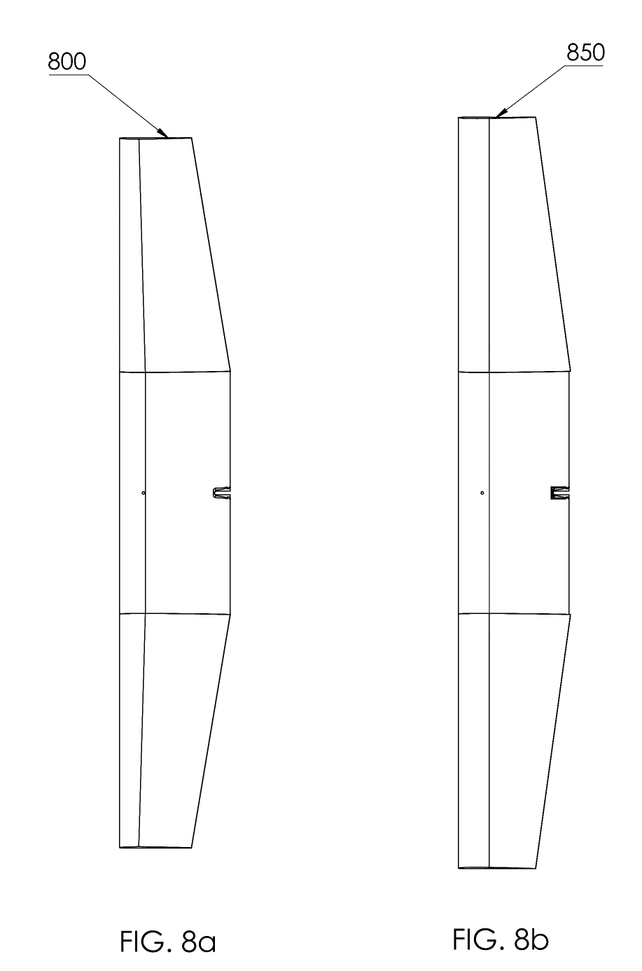

Other embodiments according to the present disclosure comprise novel and improved features of a wing structure, such as adjusted dimensions and/or wash-out. FIGS. 8a and 8b display embodiments of a wing structure according to the present disclosure with novel and improved features. Specifically, FIGS. 8a and 8b display the adjustments made from the AV wing model 800 to the X wing model 850, respectively. These adjustments can include an increased wing size and an increased wash-out. For example, based on the dimensions in Table 1 below, the wash-out can be increased by 25% (from 4 mm to 5 mm), which results in unexpected improved flight results and data, such as increased stability. These adjustments also result in several unexpected improved results, such as increased flight time, lower battery usage (on target), increased loitering time (time over target), longer wing pin design to accommodate larger wings, reduced wing loading (increased payload capabilities), and/or any future unexpected results. In some embodiments, these wing models can be used with the Raven UAV. However, it is understood that wing structures according to the present disclosure can be used with a number of different UAVs.

Table 1 below displays a more detailed breakdown of these adjustments. The wing loading and the total flying weight, or weight ready to fly, are figured with the Gimbal payload.

TABLE 1

| AV Wing | | Brand X Wings | | | |
|---|---|---|---|---|---|
| Total wing span | 50.625″ | Total wing span | 54.375″ | Difference of | 7.46% |
| Left wing | 16.688″ | Left wing | 18.562″ | Difference of | 11.30% |
| Right wing | 16.688″ | Right wing | 18.562 | Difference of | 11.30% |
| Center section | 17.250″ | Center section | 17.250″ | Difference of | 0.00% |
| Total wing area | 358.0 sq/in | Total wing area | 388.5 sq/in | Difference of | 8.52% |
| Total flying weight | 76.80 oz | Total flying weight | 80.0 oz | Difference of | 4.17% |
| Wing loading | 30.84 oz sq/ft | Wing loading | 29.63 oz sq/ft | Difference of | 4.08% |
| Wash-out | 4 mm | Wash-out | 5 mm | Difference of | 1 mm |
| Total wing span | 50⅝″ | Total wing span | 54⅝″ | Difference of | 4.0″ |

In some embodiments according to the present disclosure, in the Brand X wings, the pin locations can be the same, so as to be interchangeable with AV center wings. Furthermore, in other embodiments, the 6° root mating angle can be the same in the Brand X wings, so as to be interchangeable with AV center wings. Moreover, in yet other embodiments, the root airfoil can be the same in the Brand X wings, as well as the AV center wings.

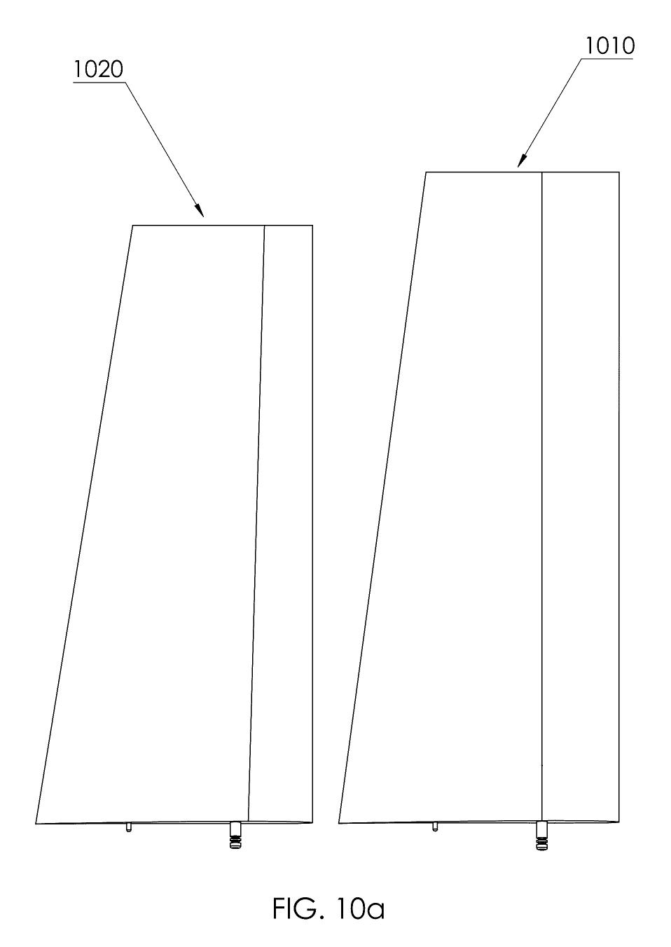

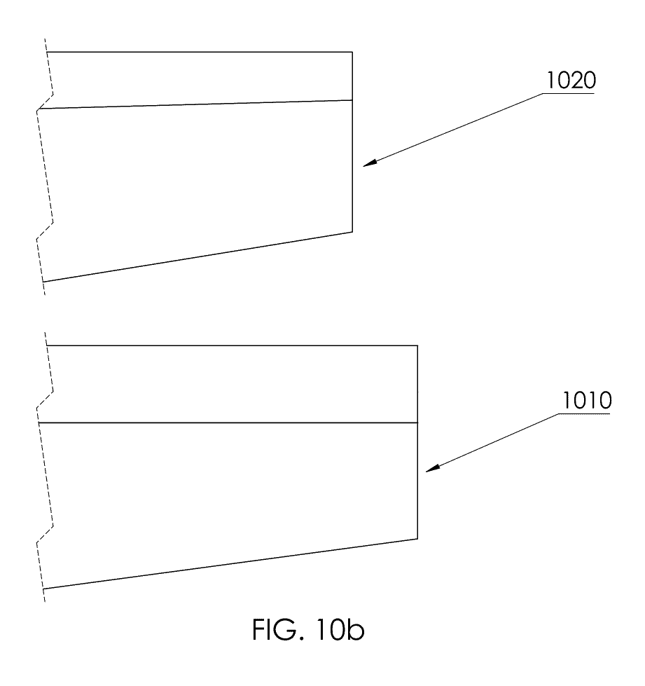

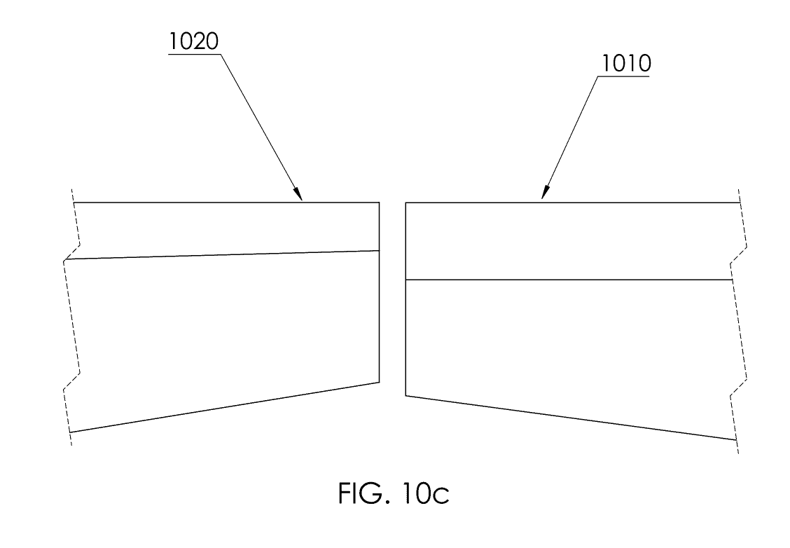

FIGS. 10a-10c display the different wing structures discussed above. In these figures, the left wing panel is used for reference. As displayed in FIGS. 10a-10c, the Brand X tip airfoil design 1010 can be longer from leading edge (L/E) to trailing edge (T/E) than in the AV model 1020.

Table 2 below is percentage breakdown chart for the factory Raven wing and the Brand X wing flight characteristics. In Table 2, (m/s)=meters per second and (m)=minutes.

TABLE 2

| | Avg. Factory | | |
|---|---|---|---|
| Telemetry | raven wings | Avg. Raven X wings | |
| Max Climb rate (m/s) | 6.99 | 8.2 | 17% |
| Avg. Air speed (m/s) | 10.2 | 9.9 | 3% |
| Avg. Bank angle (deg) | 12.6916 | 13.2 | 4% |
| Avg. Throttle (%) | 49.5 | 44.8 | 9% |
| Avg. Max Flight time (m) | 58.5 | 66.9 | 14% |

The information in Table 2 above was obtained by using a Raven Fuselage converted to Radio Control and outfitted with an Eagle Tree flight data telemetry system. The same aircraft was used to test both wing sets. Also, back to back flights where conducted in the same weather conditions.

During these testing conditions, there was a significant improvement in flight performance especially in the maximum climb rate. Average air speed was slightly lower as the increase in the wing size and stability has affected this factor. There was also an improvement in the banking angle due to the increased dihedral in the wing tips. This also allows the air vehicle to perform a tighter turn during loitering. Due to the larger wing area, the throttle percentage was able to be decreased during flight. The maximum flight time was improved due to the overall design change of the wing size and wash-out.

Table 3 below displays the test flight log for the above mentioned data.

TABLE 3

| | |
|---|---|
| Date | Aug. 31, 2015 |
| Pilot | Ron D. |
| Channel | 2.4 Ghz |
| Temp | 85-90° F. |
| Wind | 5-7 Knots |
| Lighting | Day |
| Start Time | 10:00 AM |
| End Time | 3:00 PM |
| Telemetry | Eagle Tree |

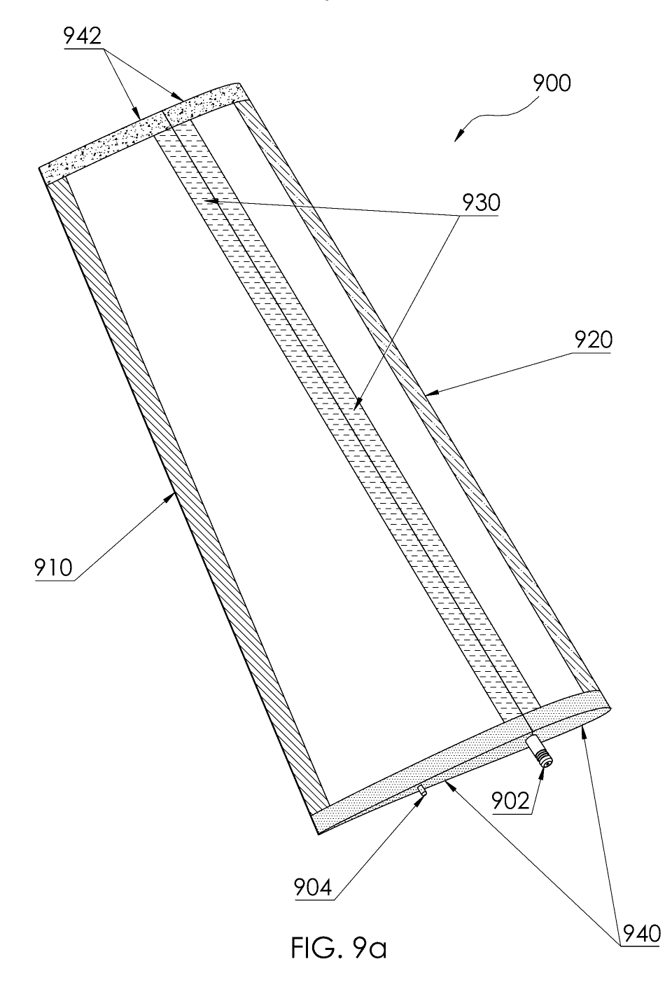

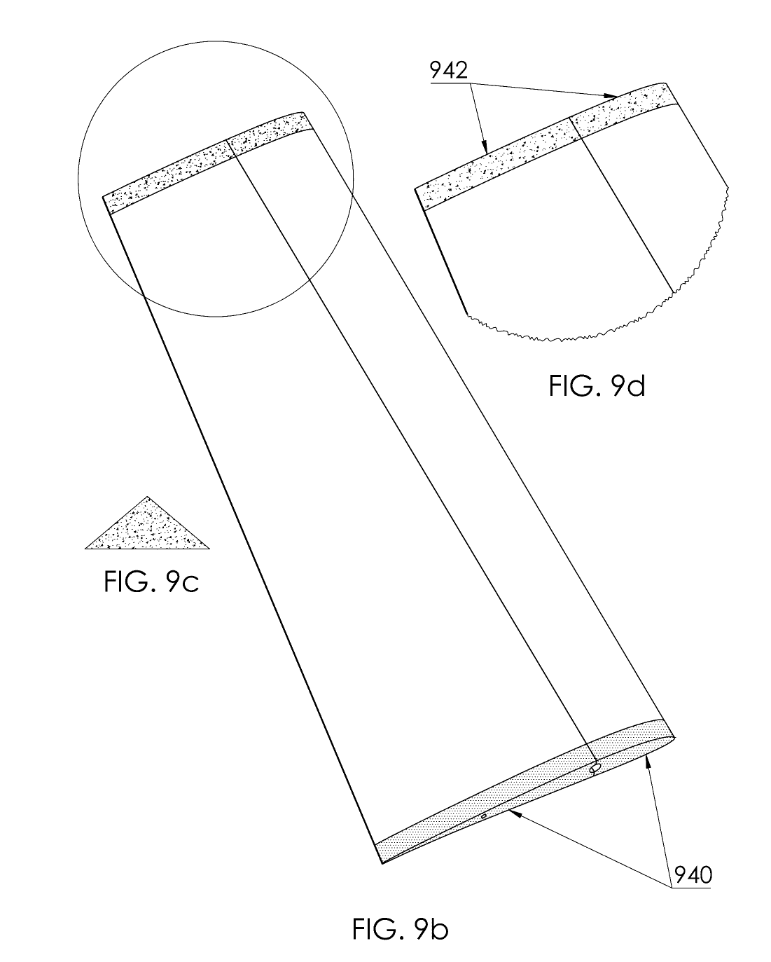

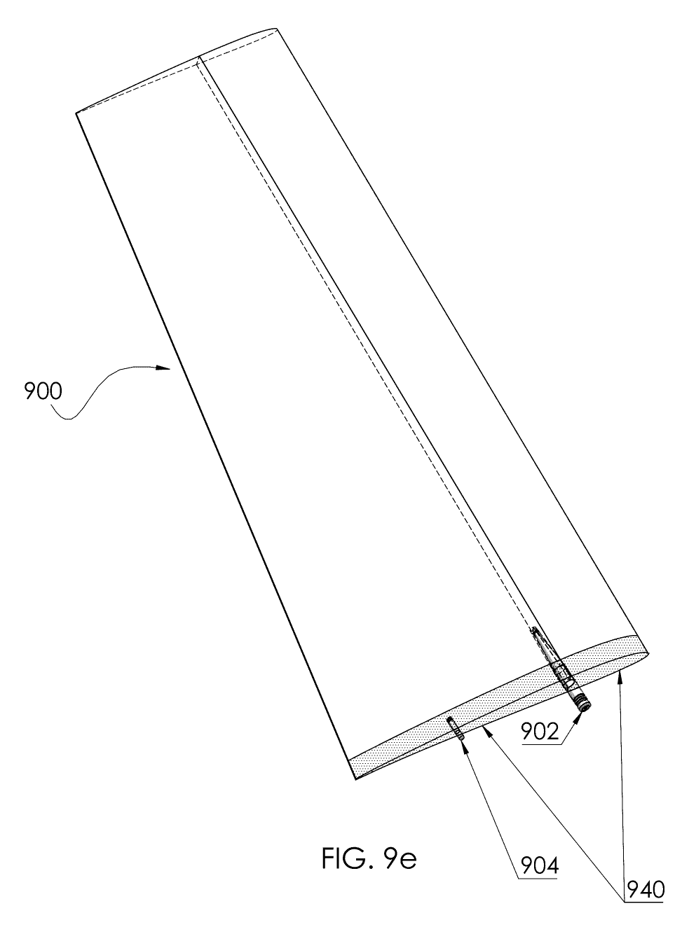

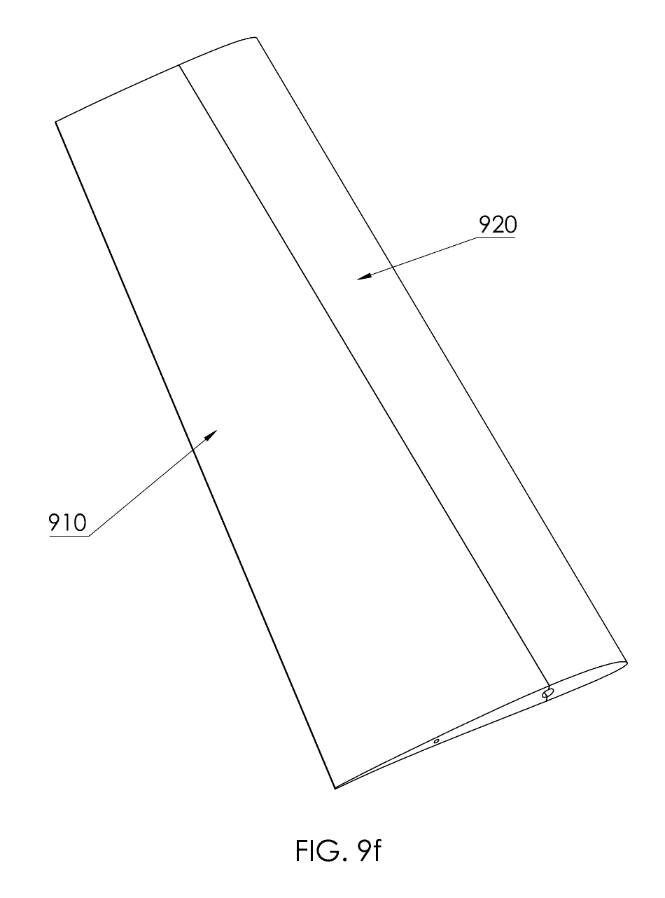

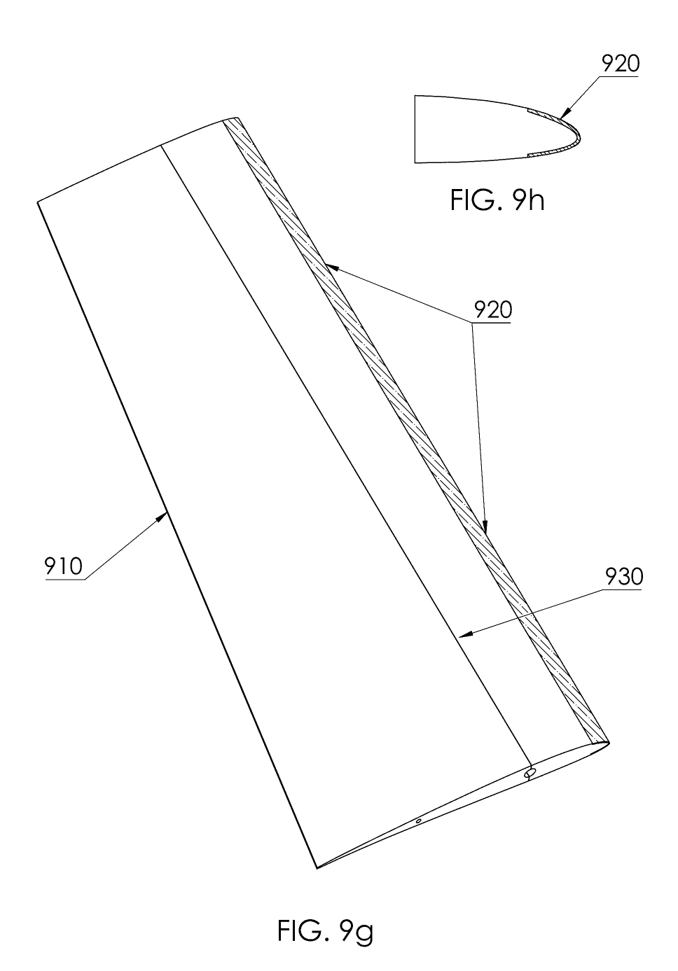

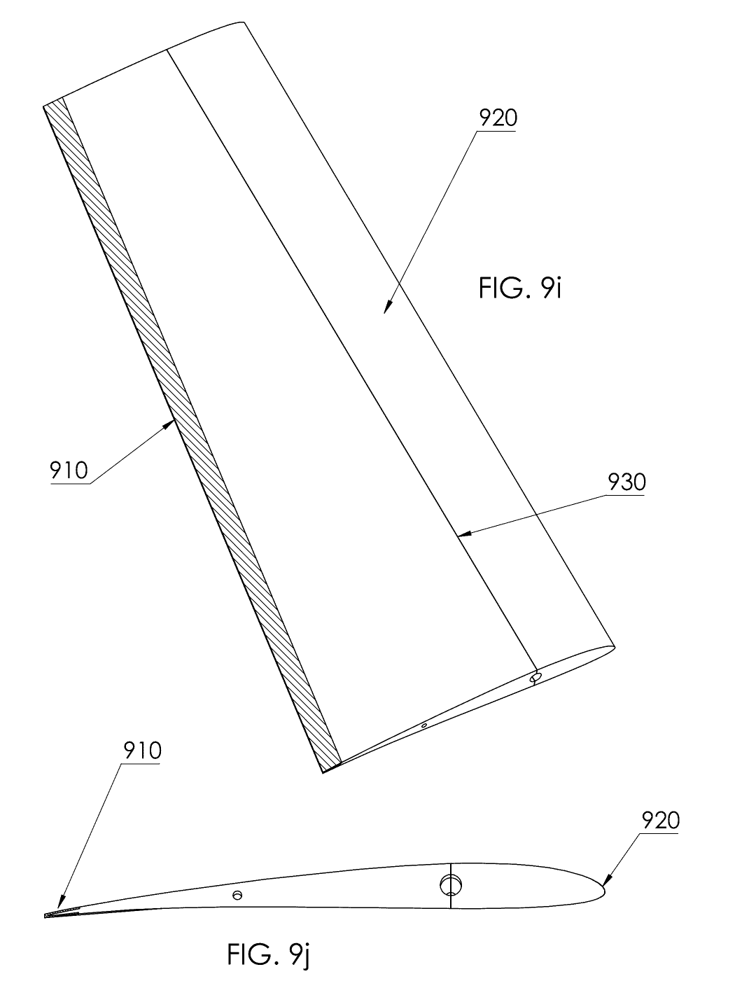

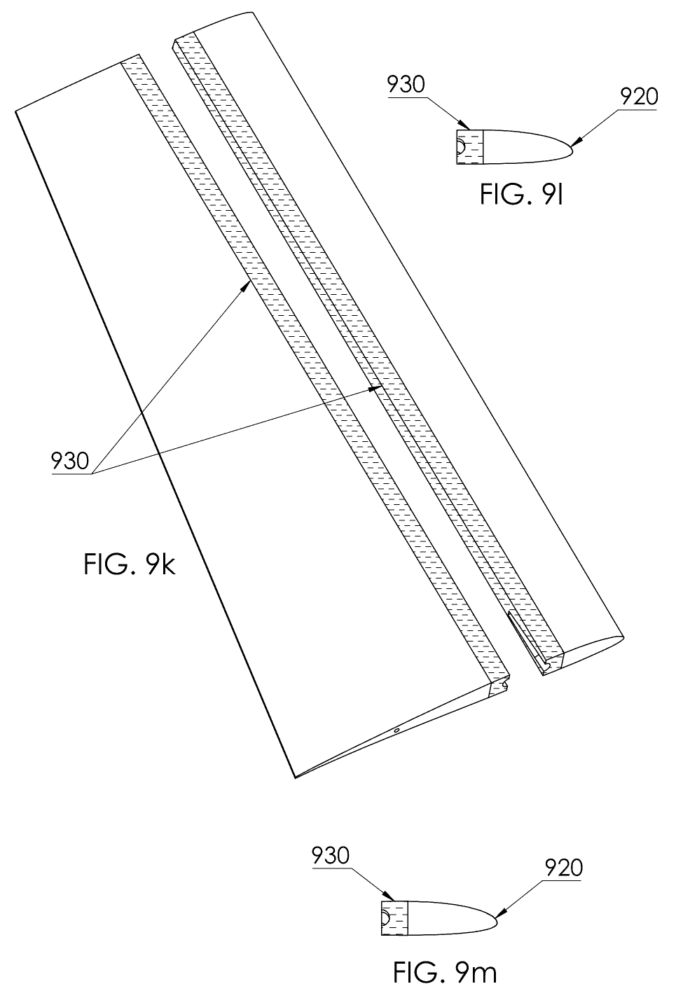

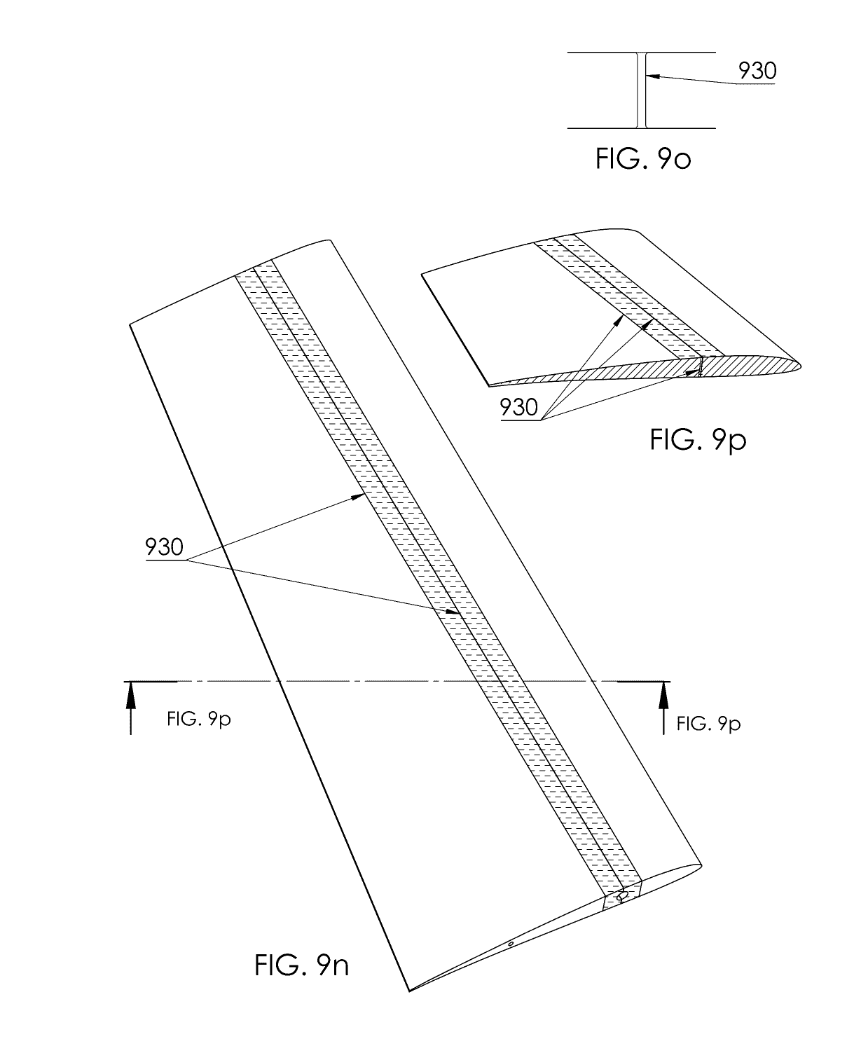

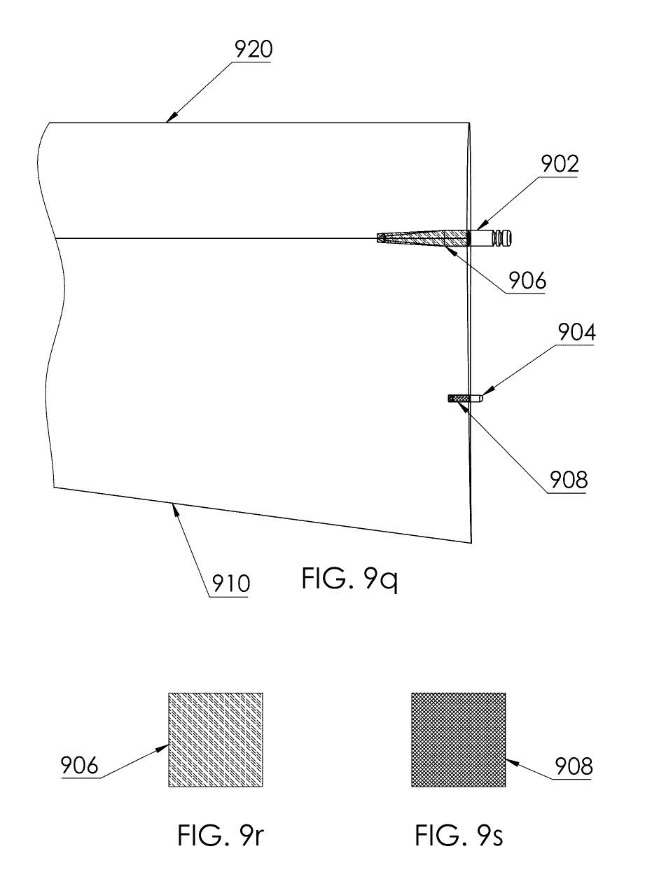

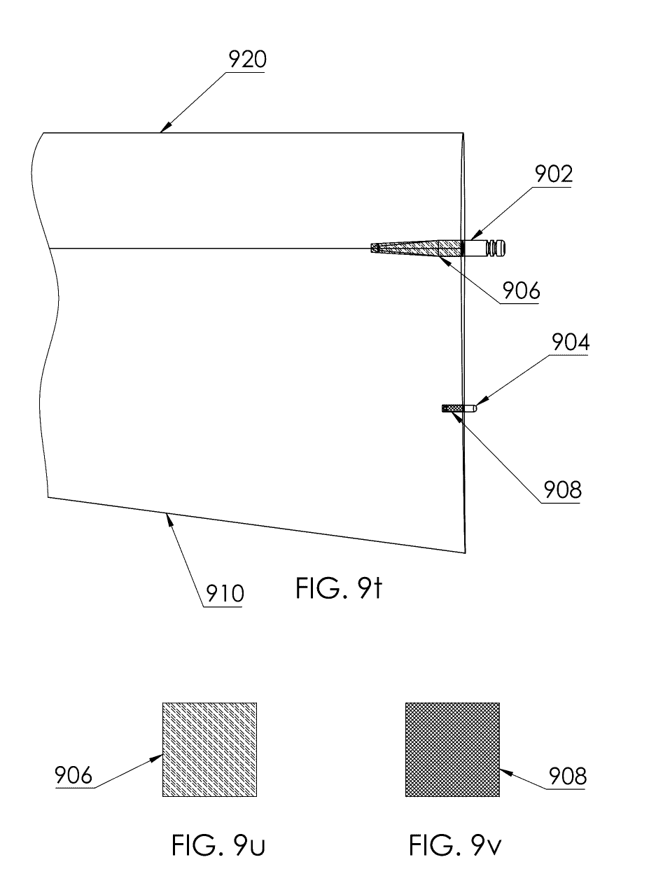

FIGS. 9a-9v are different views of another embodiment of a wing structure 900 according to the present disclosure. Wing structure 900 comprises trailing edge 910, leading edge 920, split line 930, root cap 940, tip cap 942, male connector pins 902, and anti-rotation pins 904. Specifically, these figures contain drawings of the X wing composite lay-up design. These figures show the key features in the lay-up design that will produce both right and left wing tips. There were design improvements over the OEM wings by adding material in key areas of the wing tips using unidirectional fiberglass on the main spars, as well as adding triangular fiberglass doublers to the corners and layers of fiberglass to the leading edge of the wings. These improvements can increase the structural integrity of the wings and help to prevent spar brakeage, leading edge, and corner damage.

Additionally, there were several different composite material used in FIGS. 9a-9v, including: Kevlar in the top and bottom skins and end caps, fiberglass, in the leading edge, trailing edge, corner doublers, and wing pins, unidirectional fiberglass in the main spar I beam locations, and film adhesive in the wing root, pins, and pocket areas. However, it is understood that a variety of appropriate materials can be used in the above mentioned features.

Some embodiments according to the present disclosure can comprise a 120 Kevlar/uniglass “I” beam, a 120 uniglass trailing edge, a 120 uniglass leading edge. Additionally, embodiments can comprise 120 Kevlar skin around the trailing edge and leading edge, 120 Kevlar tip caps and root caps, as well as 120 uniglass doublers. In yet other embodiments, film adhesive (F/A) can be applied under the Kevlar caps and around the pins. In further embodiments, a 120 uniglass wrap can be applied around the leading edge over the Kevlar skin, as well as around the trailing edge.

Other embodiments can comprise a foam leading edge tip, which can further comprise 120 Kevlar folded over the edge. 120 Kevlar can also be folded around the ledge of the trailing edge. In yet other embodiments, 120 Kevlar can be folded along the entire span of the wing, from root to tip, which can create an “I” beam spar. Some embodiments can comprise a foam core in the trailing edge, as well as the leading edge.

Other embodiments can comprise pin pockets for both male and female wing pins. For example, in one embodiment, a male wing pin pocket comprises 120 uniglass wrapped around a foam cut-out for the wing pin. Additionally, film adhesive (F/A) can be under the uniglass. Yet other embodiment can comprise pockets for anti-rotational pins. In these embodiments, an anti-rotation pin pocket comprises 120 uniglass wrapped around a foam cut-out for the wing pin. Once again, in these embodiments, film adhesive (F/A) can be under the uniglass. In other embodiments, pin pockets for male wing pins, female wing pins, and/or anti-rotational pins, can include a wrap of one layer of 120 uniglass.

FIG. 9a is a complete composite wing tip lay-up. FIG. 9b-9d show root and top doublers and caps. FIG. 9e displays root cap pins. FIG. 9f displays foam cove pin pockets, wherein the split line divides into two pieces—one leading edge (L/E) and one trailing edge (T/E). FIGS. 9g and 9h show a foam core L/E wrap, while FIGS. 9i and 9j display a T/E foam core wrap. FIGS. 9k-9m show a 120 Kevlar “I” beam spar. FIGS. 9n-9p display an “I” beam main spar, with uniglass, wherein all four sides of the I beam spar are full length of wing “root to tip.” FIGS. 9q-9s show lay-up “pin pockets” 906 and 908 for male connector pins and anti-rotation pins, respectively, which can include film adhesive (F/A). FIGS. 9t-9v display a lay-up “pin wraps” 907 and 909 for male connector pins and anti-rotation pins, respectively.

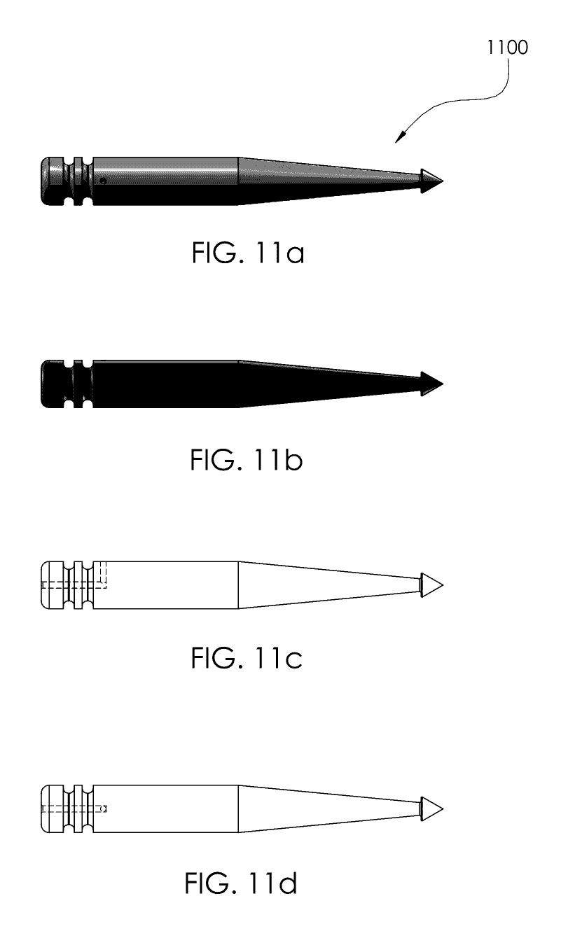

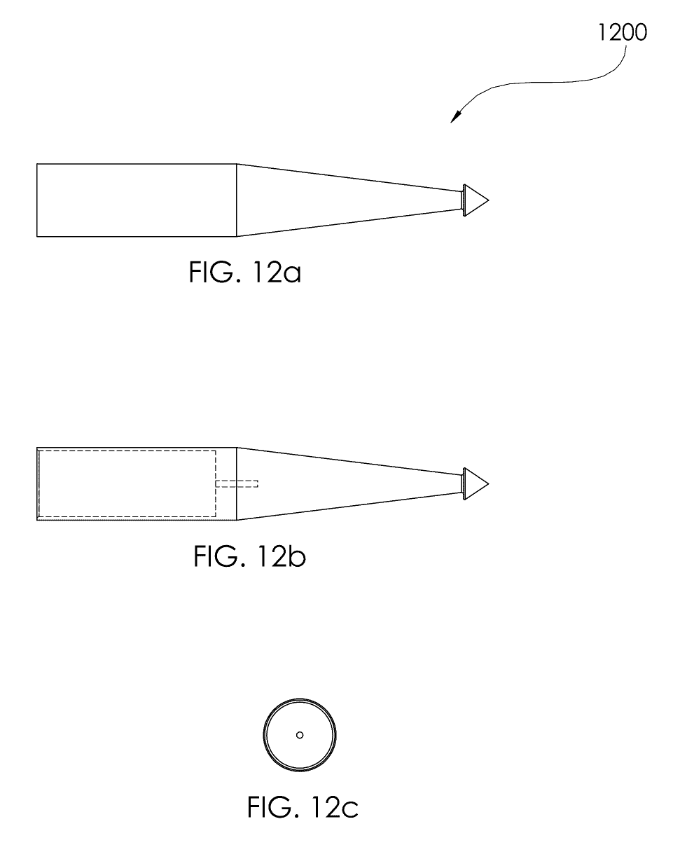

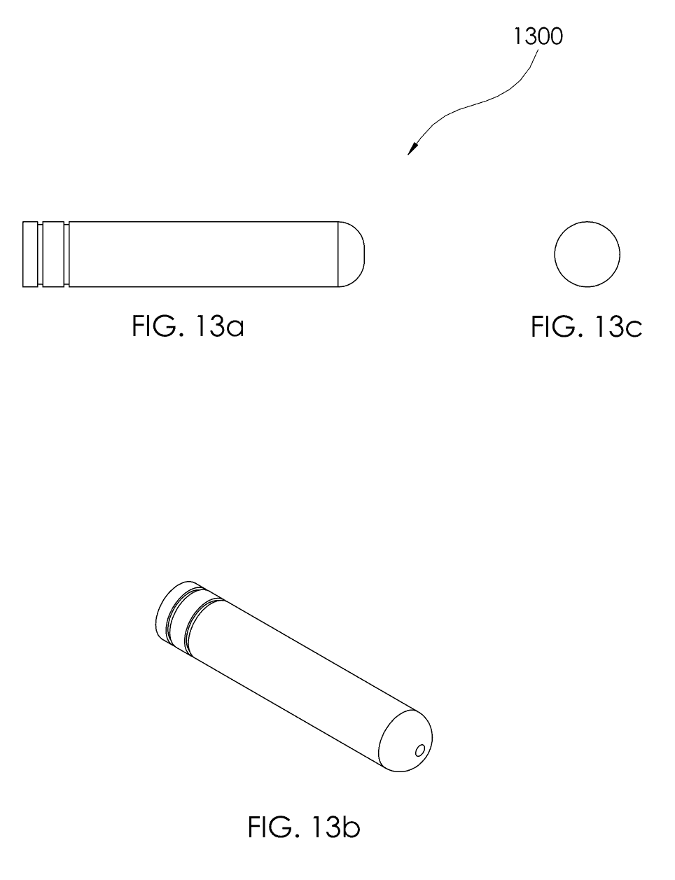

FIGS. 11a-11d, 12a-12c, and 13a-13c display different embodiments of wing pins according to the present disclosure. Specifically, FIGS. 11a-11d are male wing pins 1100, FIGS. 12a-12c are female wing pins 1200, and FIGS. 13a-13c are anti-rotation pins 1300. It is understood that male and female wing pins can be referred to in a number of different ways, such as male connector pins or female connector pins, respectively. Additionally, as the male and female wing pins can be used with the Raven UAV, they may be referred to as Raven male pins and Raven female pins, respectively. As displayed in FIGS. 11a-11d, in some embodiments according to the present disclosure, the male wing pins 1100 can have a dual O-ring design for better grip strength to the female pin inserts over the OEM. As shown in FIGS. 12a-12c, in some embodiments according to the present disclosure, the female wing pins 1200 can be slightly longer than OEM. Finally, as shown in FIGS. 13a-13c, in some embodiments according to the present disclosure, the anti-rotation pins 1300 can be longer than OEM and/or have grip groves to increase the mechanical bonding.

It is understood that embodiments presented herein are meant to be exemplary. Embodiments of the present disclosure can comprise any combination of compatible features shown in the various figures, and these embodiments should not be limited to those expressly illustrated and discussed.

Although the present disclosure has been described in detail with reference to certain configurations thereof, other versions are possible. Therefore, the spirit and scope of the disclosure should not be limited to the versions described above. The foregoing is intended to cover all modifications and alternative constructions falling within the spirit and scope of the disclosure as expressed in the appended claims, wherein no portion of the disclosure is intended, expressly or implicitly, to be dedicated to the public domain if not set forth in the claims.

We claim:

1. A wing structure, comprising:
a center wing panel;
a left wing panel connected to said center wing panel; and
a right wing panel connected to said center wing panel;
wherein said center wing panel comprises a connection portion for connecting to an unmanned aerial vehicle.

2. The wing structure of claim 1, said left wing panel comprising a tip end and a root end connected to said center wing panel, wherein the width of said root end is greater than the width of said tip end; and
said right wing panel comprising a tip end and a root end connected to said center wing panel, wherein the width of said root end is greater than the width of said tip end.

3. The wing structure of claim 2, wherein said center wing panel is below said tip end of said left wing panel and said tip end of said right wing panel.

4. The wing structure of claim 1, said left wing panel comprising a leading edge portion and a trailing edge portion, wherein the thickness of said leading edge portion is greater than the thickness of said trailing edge portion; and
said right wing panel comprising a leading edge portion and a trailing edge portion, wherein the thickness of said leading edge portion is greater than the thickness of said trailing edge portion.

5. The wing structure of claim 4, wherein said leading edge portion and said trailing edge portion of said left wing panel are divided by a split line spanning the length of said left wing panel; and
wherein said leading edge portion and said trailing edge portion of said right wing panel are divided by a split line spanning the length of said right wing panel.

6. The wing structure of claim 1, wherein said connection portion comprises a clip for connecting to an unmanned aerial vehicle.

7. A wing structure, comprising:
a center wing panel comprising one or more center connection slots;
a left wing panel comprising one or more left connection pins connected to said one or more center connection slots; and
a right wing panel comprising one or more right connection pins connected to said one or more center connection slots.

8. The wing structure of claim 7, wherein said one or more center connection slots comprise one or more female connector slots and one or more anti-rotation slots.

9. The wing structure of claim 8, wherein said one or more left connection pins comprise one or more left male connector pins and one or more left anti-rotation pins; and
wherein said one or more right connection pins comprise one or more right male connector pins and one or more right anti-rotation pins.

10. The wing structure of claim 9, wherein said one or more left male connector pins are inserted into said one or more female connector slots and said one or more left anti-rotation pins are inserted into said one or more anti-rotation slots; and
wherein said one or more right male connector pins are inserted into said one or more female connector slots and said one or more right anti-rotation pins are inserted into said one or more anti-rotation slots.

11. The wing structure of claim 7, said left wing panel comprising a leading edge portion and a trailing edge portion, wherein said leading edge portion and said trailing edge portion are divided by a split line spanning the length of said left wing panel; and
said right wing panel comprising a leading edge portion and a trailing edge portion, wherein said leading edge portion and said trailing edge portion are divided by a split line spanning the length of said right wing panel.

12. The wing structure of claim 7, wherein said center wing panel comprises a connection portion for connecting to an unmanned aerial vehicle.

13. An unmanned aerial vehicle, comprising:
a main body;
a wing structure detachably connected to said main body;
a tail boom connected to said main body;
a vertical stabilizer connected to said tail boom; and
a horizontal stabilizer connected to said tail boom.

14. The unmanned aerial vehicle of claim 13, wherein said wing structure comprises:
a center wing panel;
a left wing panel connected to said center wing panel; and
a right wing panel connected to said center wing panel.

15. The unmanned aerial vehicle of claim 14, wherein said center wing panel comprises a connection portion, said connection portion comprising a clip to detachably connect to said main body, wherein said wing structure is designed to breakaway from said main body upon impact.

16. The unmanned aerial vehicle of claim 14, said left wing panel comprising a tip end and a root end connected to said center wing panel, wherein the width of said root end is greater than the width of said tip end; and
said right wing panel comprising a tip end and a root end connected to said center wing panel, wherein the width of said root end is greater than the width of said tip end.

17. The unmanned aerial vehicle of claim 14, said left wing panel comprising a leading edge portion and a trailing edge portion, wherein the thickness of said leading edge portion is greater than the thickness of said trailing edge portion; and
said right wing panel comprising a leading edge portion and a trailing edge portion, wherein the thickness of said leading edge portion is greater than the thickness of said trailing edge portion.

18. The unmanned aerial vehicle of claim 14, said center wing panel comprising one or more center connection slots;
said left wing panel comprising one or more left connection pins connected to said one or more center connection slots; and
said right wing panel comprising one or more right connection pins connected to said one or more center connection slots

19. The unmanned aerial vehicle of claim 18, wherein said one or more center connection slots comprise one or more female connector slots and one or more anti-rotation slots;
wherein said one or more left connection pins comprise one or more left male connector pins and one or more left anti-rotation pins; and
wherein said one or more right connection pins comprise one or more right male connector pins and one or more right anti-rotation pins.

20. The unmanned aerial vehicle of claim 19, wherein said one or more left male connector pins are inserted into said one or more female connector slots and said one or more left anti-rotation pins are inserted into said one or more anti-rotation slots; and
wherein said one or more right male connector pins are inserted into said one or more female connector slots and said one or more right anti-rotation pins are inserted into said one or more anti-rotation slots.
